(19) United States
(12) Patent Application Publication
(10) Pub. No.: US 2001/0049720 A1
(43) Pub. Date: Dec. 6, 2001

(54) Standard method of access to a multimedia provider's portal

(75) Inventor: Mark Eyer, San Diego, CA (US)

Correspondence Address: Merle W. Richman, Esq., P.O. Box 3333, La Jolla, CA, 92038-3333, US

(73) Assignee: Sony Corporation and Sony Electronics, Inc.

(21) Appl. No.: 09/875,312

(22) Filed: Jun. 4, 2001

Related U.S. Application Data
(60) Provisional application No. 60/180,085, filed on Feb. 3, 2000.
(60) Provisional application No. 60/182,822, filed on Feb. 16, 2000.
(60) Provisional application No. 60/197,848, filed on Apr. 14, 2000.
(60) Provisional application No. 60/197,308, filed on Apr. 14, 2000.
(60) Provisional application No. 60/197,233, filed on Apr. 14, 2000.
(60) Provisional application No. 60/197,234, filed on Apr. 14, 2000.
(60) Provisional application No. 60/197,320, filed on Apr. 14, 2000.
(60) Provisional application No. 60/190,342, filed on Mar. 16, 2000.
(60) Provisional application No. 60/265,418, filed on Jan. 30, 2001.

(51) Int. Cl. G06F 15/16

(52) U.S. Cl. 709/203

(57) ABSTRACT

A system and method for enabling a multimedia unit to communicate with a multimedia service provider. The multimedia unit receives an IP address to a Web page of the service provider; the web page includes links to services provided by the service provider.

### CROSS REFERENCE TO RELATED APPLICATIONS

This invention is related to Utility Patent Application Ser. No. 09/775,692, filed Feb. 2, 2001, Attorney Docket Number 50N3463.01, and entitled “Web Browser Plug-in for TV”, Provisional Patent Application 60/197,312, filed Apr. 14, 2000, Attorney Docket Number 50N3465, and entitled “Method for Downloading Code”, Provisional Patent Application 60/190,342, filed Mar. 17, 2000, Attorney Docket Number 50N3465, and entitled “Set Top Box”, Provisional Patent Application 60/197,297, filed Apr. 14, 2000, Attorney Docket Number 50P3986, and entitled “Contextual Web Page”, Provisional Patent Application 60/197,848, filed Apr. 14, 2000, Attorney Docket Number 50P3988, and entitled “User Interface for a Set-Top Box”, Provisional Patent Application 60/197,308, filed Apr. 14, 2000, Attorney Docket Number 50P3984, and entitled “Method for VOD”, Provisional Patent Application 60/197,233, filed Apr. 14, 2000, Attorney Docket Number 50P3877, and entitled “Cable Modem Set Top Box”, Provisional Patent Application 60/182,822, filed Feb. 16, 2000, Attorney Docket Number 50N3464, and entitled “Support for Television Viewing in a Standard Web Browser”, Provisional Patent Application 60/180,085, filed Feb. 3, 2000, Attorney Docket Number 50N3463, and entitled “Web Browser Plug-in for TV”, Provisional Patent Application 60/197,234, filed Apr. 14, 2000, Attorney Docket Number 50P3985, and entitled “Web Based EPG Support”, Provisional Patent Application 60/197,320, filed Apr. 14, 2000, Attorney Docket Number 50P3983, and entitled “Support for tuning while viewing a Web Based EPG”, and Provisional Patent Application filed Jan. 30, 2001, Attorney Docket Number SNY001V, and entitled “Web Browser and Set Top Box Interface System and Method”, each of which is hereby incorporated by reference for their teachings.

### BACKGROUND OF THE INVENTION

1. Field of the Invention

This invention relates to enabling communication between a multimedia service provider and multimedia unit, and more particularly to enabling the service provider to list services available to the multimedia unit.

2. Description of Related Art

Multimedia service providers, such as Cable Multiple-System Operators (“MSO”), desire to provide many services to users via a multimedia unit (such a cable set top box (“STB”)) including digital audio, video, and data services. MSO commonly provide the STB to users. Accordingly, MSO can control the software operating on the STB. Users who desire additional functionality, such as video recording, may purchase third party STB. The third party STB may have an operating system or applications different from the MSO's standard STB. In order to control content and access to services, MSO have presented a request for a standardized operating system to be used in all STB so the MSO can load their specific application modules on all STBs including 3^{rd} party STB owned by users. The application module enables the MSO to control access to their system features, such as video on demand (“VOD”).

As explained more fully below, the standardization of the operating system for all STB and limitation of each STB to execute only MSO application modules greatly limits 3^{rd} party development of set top boxes. Accordingly, another solution is needed that enables any STB to access the functions available to the user from the MSO while not limiting the STB (and thus the user) to executing MSO supplied application modules.

### SUMMARY OF THE INVENTION

The present invention includes a system and method for multimedia units to communicate with a multimedia service provider where the multimedia unit is linked to a multimedia service provider and an internet via the multimedia service provider. In the system and method each multimedia unit linked to the service provider receives an Internet Protocol (“IP”) address for the multimedia service provider. Each multimedia unit may then communicate with the multimedia service provider via the IP address.

In one case, the multimedia units are set top boxes. Further, the communication with the service provider may include information about the services available from the multimedia service provider. In particular, the multimedia service provider may generate a Web page at the IP address where the Web page includes information about the services available from the multimedia service provider. The services may include multimedia programs available from the multimedia service provider. The Web page at the IP address that may include selectable links that enable each multimedia unit to access services of the multimedia service provider. The services of the multimedia service provider may include video on demand and an Electronic Program Guide.

In another case, the system and method designates a uniform resource locator (“URL”) for the multimedia service provider. Each multimedia units linked to the service provider receiving the URL. The URL is resolved into an IP address for the multimedia service provider. In another case, each set top box is capable of receiving a security module. The security module may include the URL or IP address of the multimedia service provider.

### BRIEF DESCRIPTION OF THE DRAWINGS

FIG. 1 is a block diagram digital cable television system in accordance with the present invention.

FIG. 2 is a block diagram of the set top box shown in FIG. 1.

FIG. 3 is a block diagram of a set top box according to an embodiment of the present invention.

FIG. 4 is a detailed block diagram of the set top box of FIG. 3.

FIG. 5 is a block diagram of the software architecture of the set top box of FIG. 4.

FIG. 6 is a block diagram of cable architecture in accordance with the present invention.

FIG. 7 is a diagram of an Electronic Program Guide Web page in accordance with the present invention.

FIG. 8 is a diagram of the Web page shown in FIG. 7 with a selected program displayed in the upper right corner in accordance with the present invention.

FIG. 9 is a flowchart of a process of a multimedia service provider communicating services with a multimedia unit in accordance with the present invention.

FIG. 10 is a flowchart of a process of a multimedia unit requesting services from a multimedia service provider in accordance with the present invention.

Like reference numbers and designations in the various drawings indicate like elements.

### DETAILED DESCRIPTION OF THE PREFERRED EMBODIMENTS

Throughout this description, the preferred embodiment and examples shown should be considered as exemplars, rather than as limitations on the present invention.

As noted, MSOs (one exemplary multimedia service provider) desire to provide software applications that can run on customer-owned or 3^{rd} party equipment, such as STBs. To fulfill this desire, one proposal suggests standardizing software Application Program Interfaces (API) for retail boxes. Standardizing APIs for all STB introduces many issues including: increased cost and complexity to support a standardized platform, updating the APIs to support evolving digital environments; and limited ability for consumer electronics manufacturers to differentiate their products in the marketplace.

Ultimately, the MSO wants to manage a supplied navigation application (API) that enables a user or consumer to access any services offered by the MSO. For example, if the MSO had a special offer, new services, or preview available, the navigator could present the information to the user. The navigator could also offer advanced services such as VOD service and subscription-variable EPG.

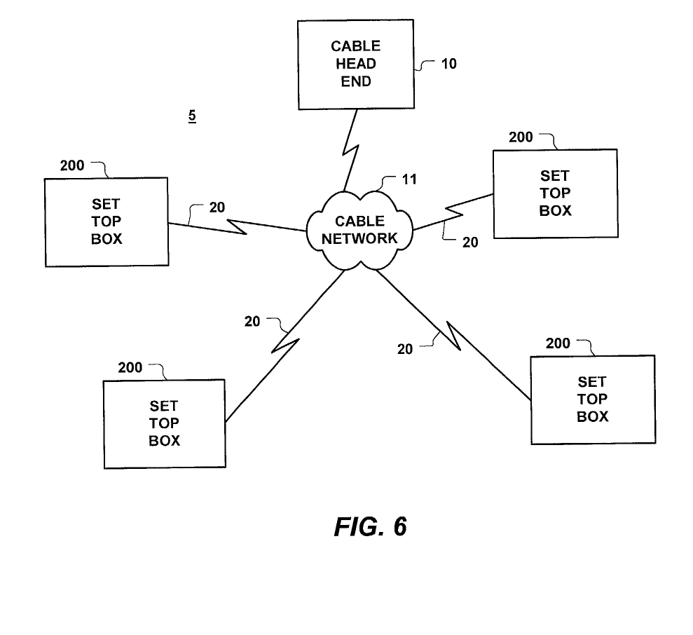

FIG. 6 is a block diagram of exemplary cable architecture 5 in which the present invention may be employed. The architecture 5 includes a cable head end 10 of a MSO (multimedia service provider), a group of set top boxes (“STB”s) 200 coupled to the cable head 10 via cables 200 and a cable network 11. The architecture 5 may include more than one head end 10 placed at various locations throughout the cable network 11. The cable network 11 is series of routers and other connectors enabling communication between one or more cable head ends 10 and the STBs 200. In an exemplary embodiment, there is more than one communication channel available between the STBs and the cable head end. In particular, there may be three channels including, a cable modem interface channel, out of band channel, and in band data channel.

It is noted that the STB operating system and software may vary with each STBs of the network 11. Even when the MSO supplies STBs 200 to end users (versus consumer purchased 3^{rd} party STB devices), different hardware and software versions of the STBs 200 may exist as the STBs evolves overtime. Additionally, the end user or consumer may purchase a 3^{rd} party STB device (the STB may be incorporated into a display unit such as TV). Third party STBs 200 may have totally different operating systems and software as compared to the same in the standard STB 200 supplied by the MSO. The present invention enables a MSO to communicate its portal (list of services and ability to access the same) to each STB 200 on the network regardless of the operating system and software of the STB 200. As described with reference to an exemplary STB 200 below, each STB 200 only needs an IP modem coupled to the MSO via the network 11 and software capable of processing Web pages.

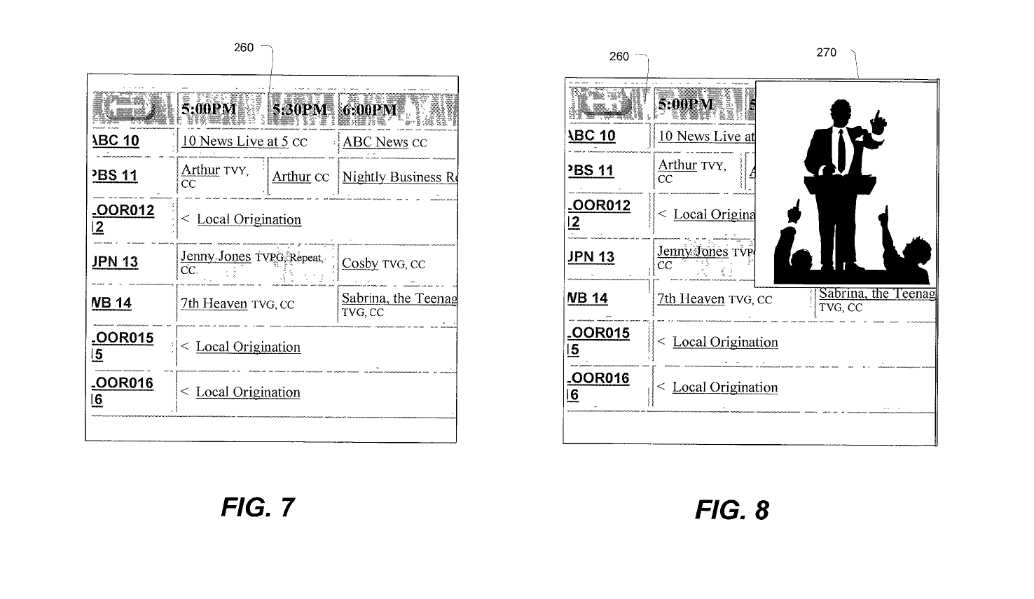

In detail, when a STB 200 is to be placed on the cable network 11 of a MSO, the STB 200 is given or receives the IP address of the MSO's portal. The MSO's portal may be retrieved from an internet that may the Internet or a local intranet for the MSO. In one embodiment, the MSO's Web-based access portal is comprised of a series of Web pages, such as shown in FIGS. 7 and 8. The Web pages indicate the services available to the STB 200 and provide selectable links to access those services. When services change, the MSO need only update the series of Web pages not update application modules resident on each STB 200.

FIG. 7 is a Web page 260 that may be generated by the MSO portal. The page 260 includes an electronic program guide (“EPG”) in HTML or other Web based language. A user of a STB 200 may have navigated through a main portal Web page and selected an EPG link to receive this Web page. The MSO may generate a generic EPG Web page to be transmitted to all STBs 200 requesting the EPG link. Additionally, the MSO may customize an EPG Web page for each STB request. For example, the EPG Web page may list only the authorized channels for the requesting STB, i.e., the STB user's subscribed channels.

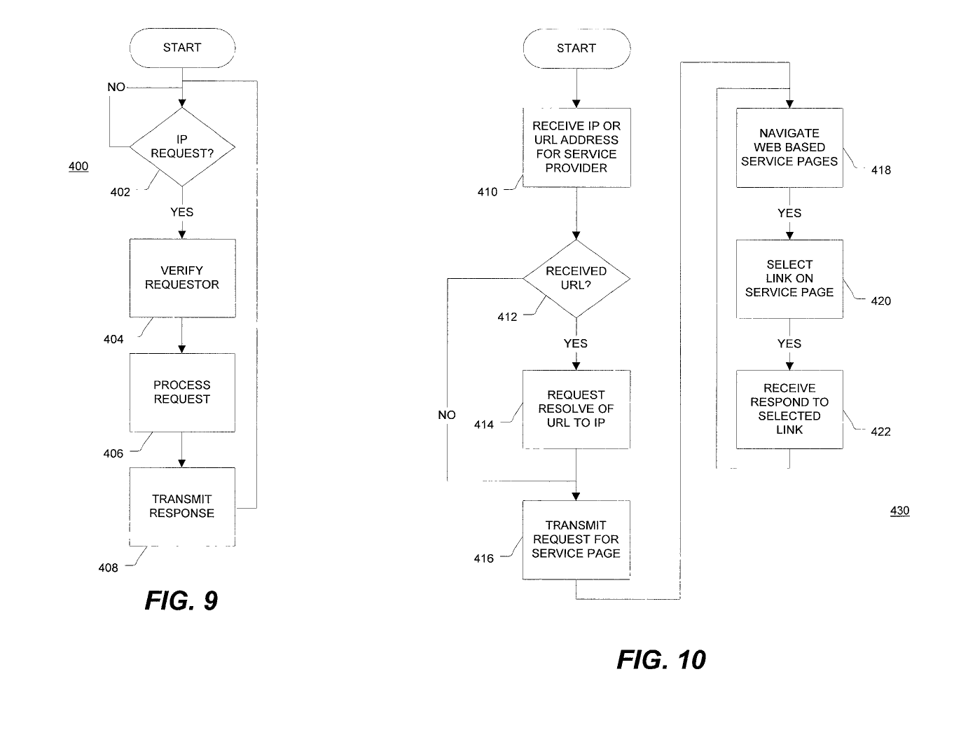

In FIG. 8, the user of a STB 200 has requested a program from the EPG page 260. The requested program is displayed in a section of the Web page 270. FIG. 9 is a flowchart of a process 400 of a multimedia service provider communicating services with multimedia units in accordance with the present invention. The service provider first receives an IP request (step 402) for services. The request may be an initial request for a main Web page listing all services available to the requestor. A user of a unit navigating the main Web page and selecting a link for a particular service may also generate the request. The service provider may verify that the requester is entitled to the services requested (step 404). Also, the service provider may verify the requestor so it can generate a customized response to the request. For example, when the unit requests an EPG, the service provider may verify the requester (step 404) and generate a Web based EPG tailored to the unit's access privileges (subscription package). The service provider processes the request (step 406). The service provider then transmits a response to the requester (step 408).

The response may a Web page. It is noted that these transmissions between the service provider and unit occur using an IP channel. Depending on the request of the unit the service provider may also transmit a response (in the form of a multimedia signal) on the in-band or out-of-band (“OOB”) channels. For example, the unit may request a Video on Demand (“VOD”) by selecting a link in a Web page. The service provider may transmit a Web page indicating the acceptance of the request and transmit the video signal for the VOD on the in-band channel.

FIG. 10 is a flowchart of a process 430 of a multimedia unit requesting services from a multimedia service provider in accordance with the present invention. The unit first determines or receives the IP or URL address for the service provider's Web-based access portal (step 410). Given there may be many service providers and consumers that may purchase multimedia units from 3^{rd} parties, the unit must determine or receive the IP or URL address that corresponds to the service provider's portal. When a service provider supplies a unit to a consumer it may program the unit with the IP or URL address of its Web-based access portal. Otherwise, the IP or URL address must be determined or received by the unit in order to communicate with the service provider's Web access portal. In one embodiment, a standardized (default) uniform resource locator (“URL”) is stored in each STB, e.g., http://mycablecompany.com. In this embodiment, the STB 200, upon startup, requests a Domain Name Server (“DNS”) to resolve the URL address into an Internet Protocol (“IP”) address for the service provider's Web based access portal. The DNS would need to correlate the URL address with the location of the requestor to determine the appropriate service provider (and thus IP address of the provider's Web-based access portal) associated with the requesting unit.

In another embodiment, specific IP addresses are standardized for each service provider. A unit upon initialization may circle through a list of IP addresses for all service providers in a region until a service provider responds indicating the unit is authorized to access the services of the service provider. In a further embodiment, each unit may accept a Point of Deployment (“POD”) security module where each service provider may supply a POD module to new consumers on their network. The consumer would insert the POD module into the unit (the POD module may be smartcard that is inserted into a smartcard reader in one embodiment). The service provider may program or have the POD module (smartcard) programmed with the IP or URL address of its Web-based access portal. The unit would receive the IP or URL address from the POD module (smartcard) upon insertion.

As noted when the unit receives a URL address of the provider's Web-based access portal (step 412), the unit requests the URL address to be resolved to the IP address of the provider's Web-based access portal (step 414). The unit then sends a request to the IP address to receive a main Web page for the service provider's access portal (step 416). A user of the unit may then navigate through a series of Web pages transmitted from the service provider. For example, one of the pages may include links to services including a link to an EPG for the unit (step 418). The user may then request access to a service of the service provider by selecting a link on a page of the Web-based access portal (420), e.g., selection of an EPG. The unit then receives a response to its selected link (step 422). As noted, the response may include a Web-based and non Web-based response.

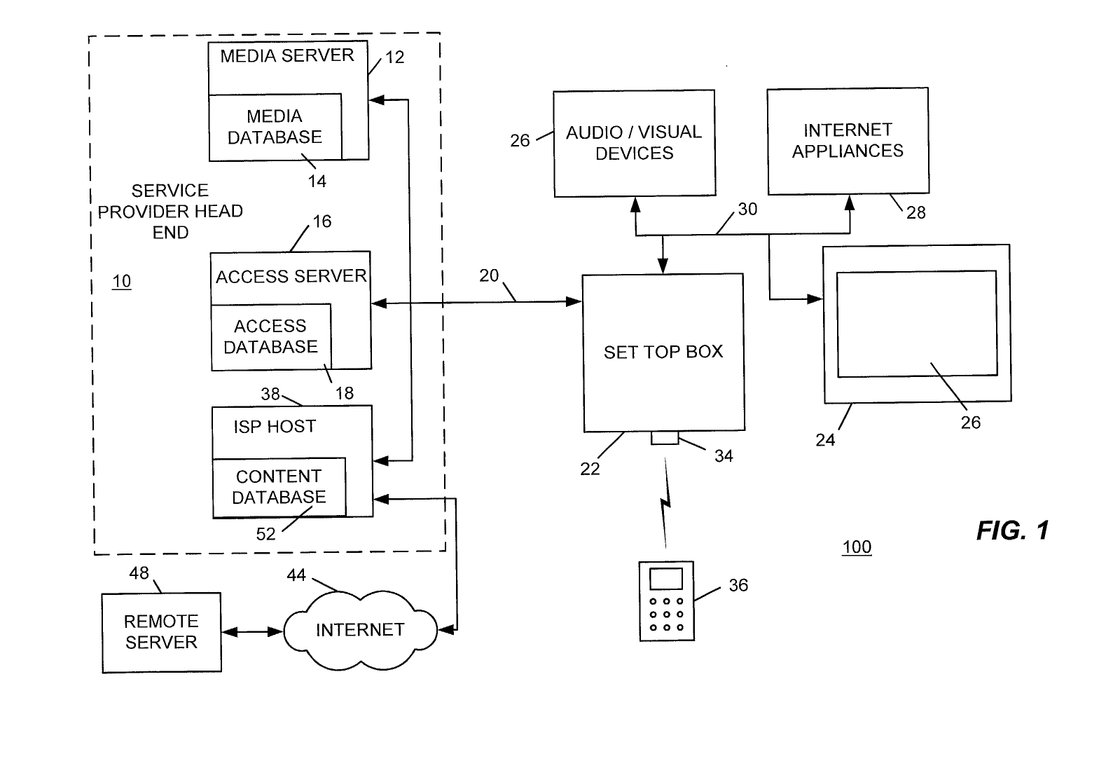

One exemplary cable architecture 100 that includes a multimedia service provider 10 and multimedia unit 22 is shown in FIG. 1 FIG. 1 is a block diagram for an exemplary interactive cable or satellite television (TV) architecture or system 100 in which the present invention may be employed. The system 100 includes a multimedia service provider head end 10, remote server 48, Internet 44, audio/visual devices 26, Internet appliances 28, television 24, multimedia unit, in particular, a set-top box (“STB”) 22, and remote control 36. The head end of the service provider 10 includes a media server 12, Web based Access portal server 16, and ISP Host 38. The media server 12 of the head end 10 provides on demand movies and other programming such as interviews with actors, games, advertisements, available merchandise, associated Web pages, and other related content obtained from a media database 14. The web-based access portal server 16 includes a web page database 18 for generating web pages detailing services and links to the same to be transmitted to STBs. The ISP host 38 includes a content database 52 and is coupled to remote servers 48 via the Internet 44. The remote servers may include another content such as video on demand (“VOD”) content The ISP host 38 includes protocols that enable communication between remove servers 48 via the Internet 44. The host 38 also includes protocols to enable Web based communication between the provider 10 and STB 22.

The media server 12 and Software code update server 16 are coupled by a transmission medium 20 to the set top box (STB) 22. The transmission medium 20 (link 525 in FIG.10) may include, for example, a conventional coaxial cable television network, a fiber optic cable network, telephone system, twisted pair, a satellite communication system, a radio frequency (RF) system, a microwave system, other wireless systems, a combination of wired and wireless systems or any of a variety of known electronic transmission mediums. In the case of a coaxial cable television network, transmission medium 20 is commonly realized at the subscriber's premises as a coaxial cable that is connected to a suitable cable connector at the rear panel of the STB 22. The STB 22 represents the media generation system 200 shown in FIG. 10.

As noted, system 100 further includes a TV 24, such as a digital television. The TV 24 includes a display 26 for displaying programming, a web browser and other content. The STB 22 may be coupled to the TV 24 and various other audio/visual devices 26 and Internet Appliances 28 by an appropriate interface 30 which can be any suitable analog or digital interface including an Institute of Electrical and Electronics Engineers (IEEE) 1394 standard interface, S-Video, Component Video, NTSC, PAL, or other analog television interface.

Set-top box 22 can generally provide for bi-directional communication over a transmission medium 20 in the case of a cable STB 22. In other embodiments, bi-directional communication can be effected using asymmetrical communication techniques possibly using dual communication media, one for the uplink and one for the downlink. In any event, the STB 22 can have its own Universal Resource Locator (URL) assigned thereto to provide for direct addressing by the head end and users of the Internet. In the case of a Direct Satellite System (DSS), the STB 22 is often referred to as an Integrated Receiver Decoder (IRD). The transmission medium is a satellite transmission at an appropriate microwave band. A satellite dish antenna with an integral Low Noise Block (LNB) is used to receive such transmissions. A down-converter converts the received signal to a lower frequency (baseband frequency) for processing by the STB 22.

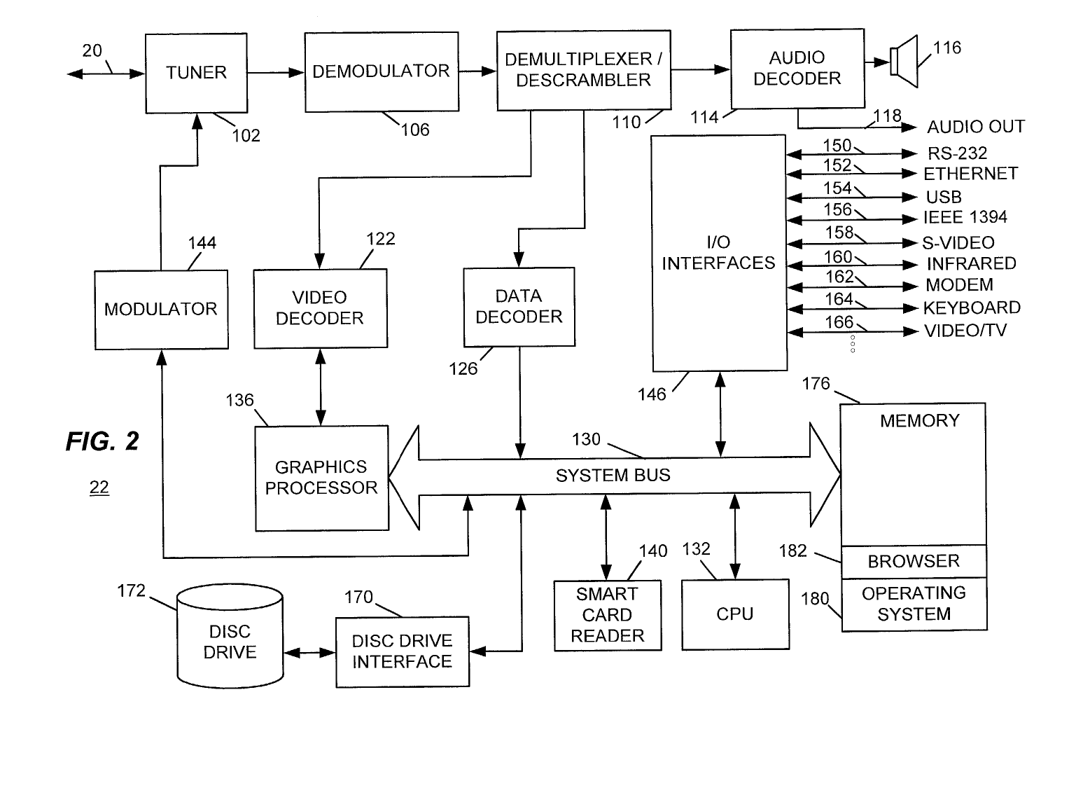

As shown in FIG. 2, the STB 22 may include a central processing unit (CPU) 132 and memory such as Random Access Memory (RAM) 176, Read Only Memory (ROM), flash memory, mass storage such as a hard disc drive 172, floppy disc drive, optical disc drive or may accommodate other electronic storage media. Such memory and storage media is suitable for storing data as well as program instructions for processes to be executed by the CPU. Information and programs stored on the electronic storage media or memory may also be transported over any suitable transmission medium such as that illustrated as 20. STB 22 may include circuitry suitable for audio decoding and processing 114, the decoding of video data 122 compressed in accordance with a compression standard such as the Motion Pictures Experts Group (MPEG) standard and other processing. It is noted that these components may be incorporated into the TV 24, eliminating the STB 22. In addition, a computer may substitute the TV 24 and STB 22. The computer may include a vary of devices capable of generating video media including a tuner card coupled to a digital network, cable television network, or DSS network.

It is noted that the STB 22 may be coupled to additional devices such as a personal computer, video cassette recorder, camcorder, digital camera, personal digital assistant and other audio/visual or Internet related devices (not shown). In addition, a data transport architecture, such as that set forth by an industry group which includes Sony Corporation and known as the Home Audio-Video Interoperability (“HAVi”) architecture may be utilized to enable interoperability among devices on a network regardless of the manufacturer of the device. This architecture may be used to create a home network system between electronic devices and Internet appliances. The STB 22 may run an operating system suitable for a home network system such as Sony Corporation's Aperios™ real time operating system. Other operating systems could also be used.

As shown in FIG. 1, the STB 22 includes an infrared (IR) receiver 34 for receiving IR signals from an input device such as the remote control 36. Alternatively, it is noted that many other control communication methods may be utilized besides IR, such as wired or wireless radio frequency, etc. In addition, it can be readily appreciated that the input device 36 may be any device suitable for controlling the STB 22 such as a remote control, personal digital assistant, laptop computer, keyboard, or computer mouse. In addition, an input device in the form of a control panel located on the TV 24 or the STB 22 can be provided.

The STB 22 may also be coupled to an independent service provider (ISP) host 38 by a suitable connection including dial-up connections, DSL (Digital Subscriber Line) or the same transmission medium 20 described above (e.g. using a cable modem) to, thus, provide access to services and content from the ISP and the Internet. STB 22 may also be used as an Internet access device to obtain information and content from remote servers such as remote server 48 via the Internet 44 using host 38 operating as an Internet portal, for example. In certain satellite STB environments, the data can be downloaded at very high speed from a satellite link, with asymmetrical upload speed from the set-top box provided via a dial-up or DSL connection.

One configuration of a digital STB 22 is shown in detail in FIG. 2. The STB 22 includes a tuner 102, demodulator 106, demultiplexer/descrambler 110, audio decoder 114, modulator 144, video decoder 122, data decoder 126, I/O interfaces 146, system bus 130, graphics processor 136, memory 176, central processing unit (“CPU”) 132, smart card reader 140, disc drive interface 170, and disc drive 172. A transmission medium 20, such as a coaxial cable, is coupled by a suitable interface to the tuner 102. Tuner 102 may include a broadcast in-band tuner for receiving content, an out-of-band (“OOB”) tuner for receiving data transmissions and a return path tuner for providing an OOB return path for outbound data (destined for example for the head end). A separate tuner (not shown) may be provided to receive conventional RF broadcast television channels. Demodulator 106 may demodulate any modulated information from the tuner 102 such MPEG-2 formatted data. The demultiplexer/descrambler circuit 110 separates the demodulated information into discrete channels of programming. The programming is divided into packets, each packet bearing an identifier called a Packet ID (PID) that identifies the packet as containing a particular type of data (e.g. audio, video, and data). The demultiplexer/descrambler circuit 110 also decrypts encrypted information in accordance with a decryption algorithm to prevent unauthorized access to programming content, for example.

Audio packets from the circuit 110 (those identified with an audio PID) are decrypted and forwarded to an audio decoder 114. The audio decoder 114 may convert the audio packets to analog audio to drive a speaker system (e.g. stereo or home theater multiple channel audio systems) or other audio system 116 (e.g. stereo or home theater multiple channel amplifier and speaker systems) or may simply provide decoded audio out at 118. Video packets from the circuit 110 (those identified with a video PID) are decrypted and forwarded to the video decoder 122. Similarly, data packets from the circuit 110 (those identified with a data PID) are decrypted and forwarded to the data decoder 126.

The data decoder 126 transmits decoded data packets to the CPU 132 via the system bus 130. Video decoder 122 passes video data to the graphics processor 136. The graphics processor is a computer optimized to processes graphics information rapidly, in particular graphics intensive data associated with Internet browsing, gaming, and multimedia applications such as those associated with MHEG (Multimedia and Hypermedia information coding Experts Group) set-top box applications. Graphics processor 136 is also coupled to the system bus 130 and operates under the control of CPU 132.It should be noted that the function of a graphics processor 136 may be unnecessary in set-top box designs having lower capabilities. Also the CPU 132 may function as a graphics processor in some applications.

The STB may include a smart card reader 140 for communicating with a so-called “smart card” or POD module, where the smart card reader 140 acts as a Conditional Access Module (CAM). In CAM systems the smart card reader may include a central processor unit (CPU) with associated RAM and ROM memory. Such smart card based CAMs are conventionally utilized for authentication of the user, of transactions carried out by the user, and of services and storage of cryptography keys. For example, the CAM may be used to provide the key for decoding incoming cryptographic data. Upon purchase of a STB 22, the service provider 10 may include a URL or IP address for the web-based access portal of the service provider. STB 22 may operate in a bi-directional communication mode. Accordingly, data and other information may be transmitted from the head end 10 to the STB 22 and from the STB 22 using an out-of-band channel. In one embodiment, the data passes through the system bus 130, modulator 144, and the tuner 102 (operating as a return path OOB tuner) to the transmission medium 20. This enables the STB 22 user to send information to the head end 10, e.g., service requests, software updates, or changes and registration information.

Set-top box 22 may include any of a plurality of I/O (Input/Output) signals at I/O interface 146 for interconnection with other devices. By way of example, and not limitation, a serial RS-232 signal may be provided at port 150 to enable interconnection to any suitable serial device supported by the STB 22's internal software. Similarly, communication with appropriately compatible devices can be provided via an Ethernet port 152, a USB (Universal Serial Bus) port 154, an IEEE 1394 (Firewire or I-Link) port 156, S-video port 158, or infrared port 160. These interfaces may be utilized to interconnect the STB 22 with any of a variety of devices such as storage devices, audio/visual devices 24, gaming devices (not shown), and Internet Appliances 28.

I/O interfaces 146 can include a modem port 162 to facilitate high speed or alternative access to the Internet or other data communication functions. In one preferred embodiment, modem port 162 includes a DOCSIS (Data Over Cable System Interface Specification) cable modem. This modem facilitates high speed network access over a cable system when port 162 is appropriately coupled to a transmission medium 20 embodied as a coaxial cable. A PS/2 or other keyboard/mouse/joystick coupled to port 164 may be used to enable data entry into the STB 22. STB 22 also may include a basic video output port 166 for direct connection to a television set such as 24. In one embodiment, Video output port 166 can provide composite video formatted as National Television System Committee (“NTSC”) video. In some embodiments, the video output port 166 may be coupled directly to the graphics processor 136 or the demultiplexer/descrambler 110 rather than passing through the system bus 130 as illustrated in the exemplary block diagram. S-Video signals at output port 158 can be similarly provided without passing through the system bus 130 if desired in other embodiments.

The infrared port 160 may be embodied as an infrared receiver 34 as illustrated in FIG. 1. The infrared port 160 may receive commands from an infrared remote control 36, infrared keyboard or other infrared control device. Although not explicitly shown, front panel controls may be used in some embodiments to directly control the operation of the STB 22 through a front panel control interface coupled to the I/O interfaces 146. Selected interfaces such as those described above and others can be provided in STB 22 in various combinations as required or desired. STB 22 may also include a disc drive interface 170 and disc drive mass storage 172 for storage of content and data as well as providing storage of programs (software code) operating on CPU 132. STB 22 may also include other storage mediums such as a floppy disc drive, CD ROM drive, CD R/W drive, DVD drive, and others. CPU 132 is coupled through the system bus 130 to the memory 176. Memory 176 may include any suitable memory technology including Random Access Memory (RAM), Read Only Memory (ROM), Flash memory, Electrically Erasable Programmable Read Only Memory (EEPROM), and others.

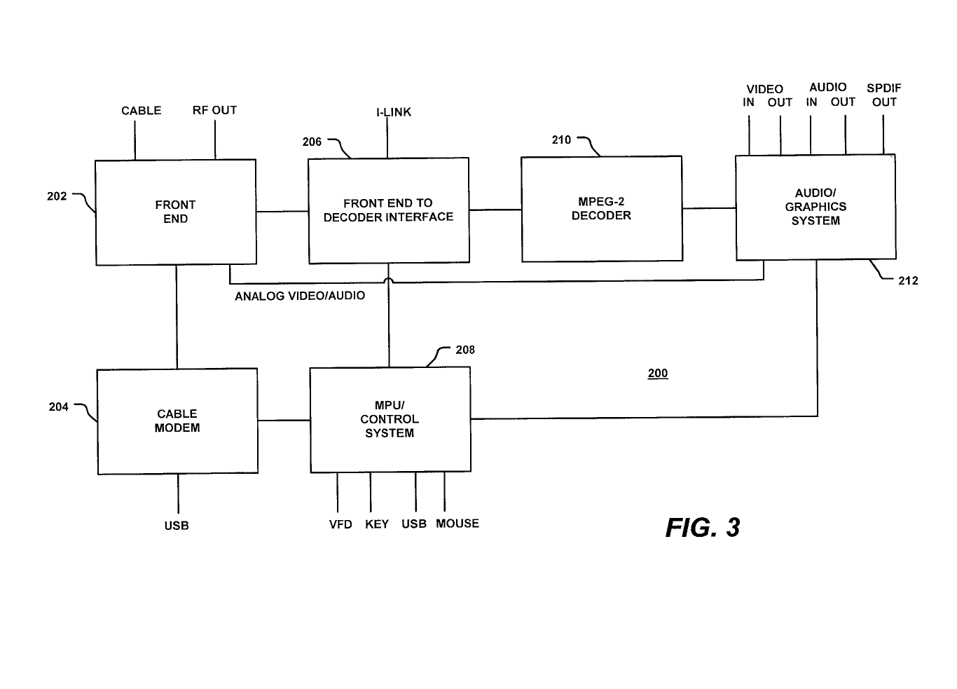

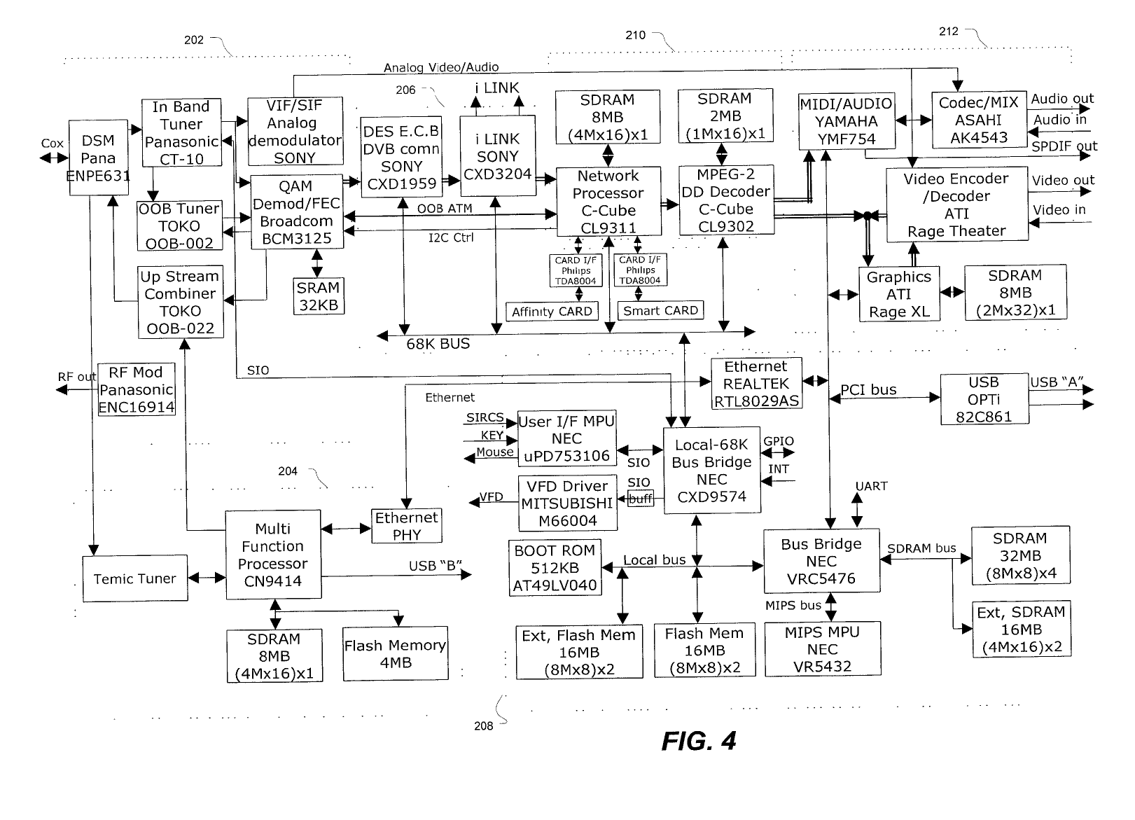

FIG. 3 is a basic block diagram of the media generation system in the form of an exemplary STB 200 capable of use with the present invention. A detailed block diagram of the STB 200 is shown in FIG. 4. STB 200 is described in detail in provisional Patent Application 60/197,233, filed Apr. 14, 2000, Attorney Docket Number 50P3877, entitled “Cable Modem Set Top Box” which is incorporated by reference herein for its teachings on the STB 200. Accordingly, the STB 200 is only briefly described with reference to FIGS. 3 and 4. The STB 200 includes a front end 202, cable modem 204, front end to decoder interface 206, MPU/control system 208, MPEG-2 Decoder 210, and Audio/Graphics System 212. The front end 202 may be coupled to a cable head end 10 via a cable 20 and cable network 11 as shown in FIG. 6. The front end 202 could be modified to communicate with alternative digital or analog content providers. The front end to decoder interface 206 links the front end 202, MPU/control system 208, and MPEG-2 decoder 210. The interface 206 includes card readers and an iLink™ interface. The MPEG-2 decoder 210 receives MPEG-2 content from the front end 202 (via the interface 206), and decodes the MPEG-2 content into frames for processing by the Audio/graphics system 212. The microprocessor unit (“MPU”)/control system 208 controls the primary operation of the STB 200. The system 208 includes a MPU that supports layers for drivers up to application program interfaces (“APIs”) that control the interaction of the components of the STB 200.

The system 208 may receive control data and software code update data from the front end 202 (via the interface 206) and send control data to the front end (and ultimately a content provider or media signal generator) via the cable modem 204 and front end 202. The cable modem 204 is coupled to the front end 202 and MPU/control system 208 and can retrieve and place digital data packets on the cable system (in this embodiment). The audio/graphics system 212 can receive video and audio content information from the front end (for analog video/audio), the MPEG-2 decoder (digital audio and video), and the MPU/control system 208.

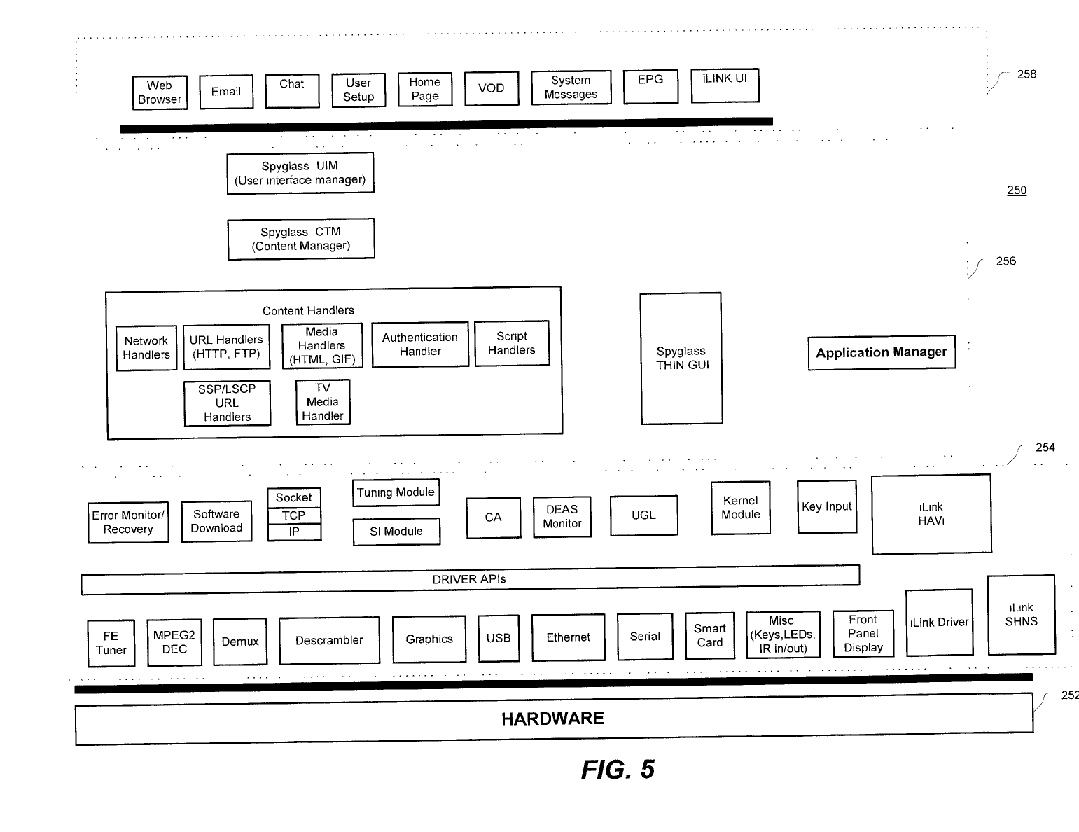

A block diagram of the software architecture 250 for the STB 200 is shown in FIG. 5. The architecture 250 depicts the hardware layer 252, hardware layer interface/driver layer 254, middleware layer 256, and local content/application layer 258. During normal operation of the STB 200, the driver APIs are loaded in the memory of the control system 208. The driver APIs enable communication of events between the MPU and the hardware modules of the STB 200. As shown in FIG. 5, the hardware modules include the Front End Tuner, MPEG-2 Decoder, Demultiplexer, Descrambler, Graphics, Ethernet, Serial port, Smart Card, miscellaneous hardware including keyboard, light-emitting-diodes, infrared, and front panel display.

The middleware layer 256 includes a group of content handlers, spyglass content manager, spyglass user interface manager, spyglass thin graphical user interface (“GUI”), and application manager. The middleware layer 256 enables the handlers and managers to run on multiple platforms with little regard for the actual operating system in place. At the top layer is the application layer where user applications reside (e.g. web browser, email, Chat, user setup, home page of STB, Video On Demand (VOD), EPG, and iLink user interface).

While this invention has been described in terms of a best mode for achieving this invention's objectives, it will be appreciated by those skilled in the art that variations may be accomplished in view of these teachings without deviating from the spirit or scope of the present invention. For example, the present invention may be implemented using any combination of computer programming software, firmware or hardware (e.g., a software language other than Java, such as C++ or others may be used to implement the invention). As a preparatory step to practicing the invention or constructing an apparatus according to the invention, the computer programming code (whether software or firmware) according to the invention will typically be stored in one or more machine readable storage mediums such as fixed (hard) drives, diskettes, optical disks, magnetic tape, semiconductor memories such as ROMs, PROMs, etc., thereby making an article of manufacture in accordance with the invention. The article of manufacture containing the computer programming code is used by either executing the code directly from the storage device, by copying the code from the storage device into another storage device such as a hard disk, RAM, etc. or by transmitting the code on a network for remote execution.

What is claimed is:

1. A method for a plurality of multimedia units linked to a multimedia service provider and an internet via the multimedia service provider to communicate with the service provider, comprising the steps of:
a) each of the plurality of multimedia units receiving an Internet Protocol (“IP”) address for the multimedia service provider; and
b) each of the plurality of multimedia units communicating with the multimedia service provider via the IP address.

2. The method for a plurality of multimedia units linked to a multimedia service provider and an internet via the multimedia service provider to communicate with the service provider of claim 1, wherein the multimedia units are set top boxes.

3. The method for a plurality of multimedia units linked to a multimedia service provider and an internet via the multimedia service provider to communicate with the service provider of claim 1, wherein the communication with the service provider includes information about the services available from the multimedia service provider.

4. The method for a plurality of multimedia units linked to a multimedia service provider and an internet via the multimedia service provider to communicate with the service provider of claim 3, further comprising the step of the multimedia service provider generating a Web page at the IP address that includes information about the services available from the multimedia service provider.

5. The method for a plurality of multimedia units linked to a multimedia service provider and an internet via the multimedia service provider to communicate with the service provider of claim 1, wherein the communication with the service provider includes the multimedia programs available from the multimedia service provider.

6. The method for a plurality of multimedia units linked to a multimedia service provider and an internet via the multimedia service provider to communicate with the service provider of claim 5, further comprising the step of the multimedia service provider generating a Web page at the IP address that includes the multimedia programs available from the multimedia service provider.

7. The method for a plurality of multimedia units linked to a multimedia service provider and an internet via the multimedia service provider to communicate with the service provider of claim 1, wherein the communication with the service provider enables each of the plurality of multimedia units to access services of the multimedia service provider.

8. The method for a plurality of multimedia units linked to a multimedia service provider and an internet via the multimedia service provider to communicate with the service provider of claim 7, further comprising the step of the multimedia service provider generating a Web page at the IP address that includes links to enable each of the plurality of multimedia units to access services of the multimedia service provider.

9. The method for a plurality of multimedia units linked to a multimedia service provider and an internet via the multimedia service provider to communicate with the service provider of claim 7, wherein the communication with the service provider enables each of the plurality of multimedia units to select multimedia programs available from the multimedia service provider.

10. The method for a plurality of multimedia units linked to a multimedia service provider and an internet via the multimedia service provider to communicate with the service provider of claim 8, wherein the services of the multimedia service provider include video on demand.

11. The method for a plurality of multimedia units linked to a multimedia service provider and an internet via the multimedia service provider to communicate with the service provider of claim 8, wherein the services of the multimedia service provider include an Electronic Program guide.

12. The method for a plurality of multimedia units linked to a multimedia service provider and an internet via the multimedia service provider to receive information about the service provider of claim 1, wherein step a) includes:
i) designating a uniform resource locator (“URL”) for the multimedia service provider;
ii) each of the plurality of multimedia units receiving the URL; and
iii) resolving the URL into an IP address for the multimedia service provider.

13. The method for a plurality of multimedia units linked to a multimedia service provider and an internet via the multimedia service provider to communicate with the service provider of claim 12, wherein the multimedia units are set top boxes.

14. The method for a plurality of multimedia units linked to a multimedia service provider and an internet via the multimedia service provider to communicate with the service provider of claim 12, wherein the communication with the service provider includes information about the services available from the multimedia service provider.

15. The method for a plurality of multimedia units linked to a multimedia service provider and an internet via the multimedia service provider to communicate with the service provider of claim 14, further comprising the step of the multimedia service provider generating a Web page at the IP address that includes information about the services available from the multimedia service provider.

16. The method for a plurality of multimedia units linked to a multimedia service provider and an internet via the multimedia service provider to communicate with the service provider of claim 12, wherein the communication with the service provider includes the multimedia programs available from the multimedia service provider.

17. The method for a plurality of multimedia units linked to a multimedia service provider and an internet via the multimedia service provider to communicate with the service provider of claim 16, further comprising the step of the multimedia service provider generating a Web page at the IP address that includes the multimedia programs available from the multimedia service provider.

18. The method for a plurality of multimedia units linked to a multimedia service provider and an internet via the multimedia service provider to communicate with the service provider of claim 12, wherein the communication with the service provider enables each of the plurality of multimedia units to access services of the multimedia service provider.

19. The method for a plurality of multimedia units linked to a multimedia service provider and an internet via the multimedia service provider to communicate with the service provider of claim 18, further comprising the step of the multimedia service provider generating a Web page at the IP address that includes links to enable each of the plurality of multimedia units to access services of the multimedia service provider.

20. The method for a plurality of multimedia units linked to a multimedia service provider and an internet via the multimedia service provider to communicate with the service provider of claim 18, wherein the communication with the service provider enables each of the plurality of multimedia units to select multimedia programs available from the multimedia service provider.

21. The method for a plurality of multimedia units linked to a multimedia service provider and an internet via the multimedia service provider to communicate with the service provider of claim 19, wherein the services of the multimedia service provider include video on demand.

22. The method for a plurality of multimedia units linked to a multimedia service provider and an internet via the multimedia service provider to communicate with the service provider of claim 19, wherein the services of the multimedia service provider include an Electronic Program guide.

23. The method for a plurality of multimedia units linked to a multimedia service provider and an internet via the multimedia service provider to receive information about the service provider of claim 1, wherein each of the plurality of multimedia units includes security module wherein step a) includes:
i) designating a uniform resource locator (“URL”) for the multimedia service provider on the service module;
ii) each of the plurality of multimedia units retrieving the URL from the service module; and
iii) resolving the URL into an IP address for the multimedia service provider.

24. The method for a plurality of multimedia units linked to a multimedia service provider and an internet via the multimedia service provider to receive information about the service provider of claim 1, wherein each of the plurality of multimedia units includes security module wherein step a) includes:
i) designating an IP address for the multimedia service provider on the service module; and
ii) each of the plurality of multimedia units retrieving the IP address from the service module.

25. The method for a plurality of multimedia units linked to a multimedia service provider and an internet via the multimedia service provider to communicate with the service provider of claim 24, wherein the multimedia units are set top boxes.

26. The method for a plurality of multimedia units linked to a multimedia service provider and an internet via the multimedia service provider to communicate with the service provider of claim 24, wherein the communication with the service provider includes information about the services available from the multimedia service provider.

27. The method for a plurality of multimedia units linked to a multimedia service provider and an internet via the multimedia service provider to communicate with the service provider of claim 26, further comprising the step of the multimedia service provider generating a Web page at the IP address that includes information about the services available from the multimedia service provider.

28. The method for a plurality of multimedia units linked to a multimedia service provider and internet via the multimedia service provider to communicate with the service provider of claim 24, wherein the communication with the service provider includes the multimedia programs available from the multimedia service provider.

29. The method for a plurality of multimedia units linked to a multimedia service provider and an internet via the multimedia service provider to communicate with the service provider of claim 28, further comprising the step of the multimedia service provider generating a Web page at the IP address that includes the multimedia programs available from the multimedia service provider.

30. The method for a plurality of multimedia units linked to a multimedia service provider and an internet via the multimedia service provider to communicate with the service provider of claim 24, wherein the communication with the service provider enables each of the plurality of multimedia units to access services of the multimedia service provider.

31. The method for a plurality of multimedia units linked to a multimedia service provider and an internet via the multimedia service provider to communicate with the service provider of claim 30, further comprising the step of the multimedia service provider generating a Web page at the IP address that includes links to enable each of the plurality of multimedia units to access services of the multimedia service provider.

32. The method for a plurality of multimedia units linked to a multimedia service provider and an internet via the multimedia service provider to communicate with the service provider of claim 30, wherein the communication with the service provider enables each of the plurality of multimedia units to select multimedia programs available from the multimedia service provider.

33. The method for a plurality of multimedia units linked to a multimedia service provider and an internet via the multimedia service provider to communicate with the service provider of claim 31, wherein the services of the multimedia service provider include video on demand.

34. The method for a plurality of multimedia units linked to a multimedia service provider and an internet via the multimedia service provider to communicate with the service provider of claim 31, wherein the services of the multimedia service provider include an Electronic Program guide.

35. An article of manufacture for use in a plurality of multimedia units linked to a multimedia service provider and an internet via the multimedia service provider to communicate with the service provider, the article of manufacture comprising computer readable storage media including program logic embedded therein that causes control circuitry to perform the steps of:
a) selecting one of the plurality of data paths based on the code to be transmitted; and
b) transmitting the code to the at least one remote unit on the selected data path.

36. The article of manufacture for use in downloading code to at least one remote unit of claim 15, wherein the units are set top boxes.

37. An article of manufacture for use in a plurality of multimedia units linked to a multimedia service provider and an internet via the multimedia service provider to communicate with the service provider, the article of manufacture comprising computer readable storage media including program logic embedded therein that causes control circuitry to perform the steps of:
a) each of the plurality of multimedia units receiving an Internet Protocol (“IP”) address for the multimedia service provider; and
b) each of the plurality of multimedia units communicating with the multimedia service provider via the IP address.

38. The article of manufacture for use in a plurality of multimedia units linked to a multimedia service provider and an internet via the multimedia service provider to communicate with the service provider of claim 37, wherein the multimedia units are set top boxes.

39. The article of manufacture for use in a plurality of multimedia units linked to a multimedia service provider and an internet via the multimedia service provider to communicate with the service provider of claim 37, wherein the communication with the service provider includes information about the services available from the multimedia service provider.

40. The article of manufacture for use in a plurality of multimedia units linked to a multimedia service provider and an internet via the multimedia service provider to communicate with the service provider of claim 39, further comprising the step of the multimedia service provider generating a Web page at the IP address that includes information about the services available from the multimedia service provider.

41. The article of manufacture for use in a plurality of multimedia units linked to a multimedia service provider and an internet via the multimedia service provider to communicate with the service provider of claim 37, wherein the communication with the service provider includes the multimedia programs available from the multimedia service provider.

42. The article of manufacture for use in a plurality of multimedia units linked to a multimedia service provider and an internet via the multimedia service provider to communicate with the service provider of claim 41, further comprising the step of the multimedia service provider generating a Web page at the IP address that includes the multimedia programs available from the multimedia service provider.

43. The article of manufacture for use in a plurality of multimedia units linked to a multimedia service provider and an internet via the multimedia service provider to communicate with the service provider of claim 37, where in the communication with the service provider enables each of the plurality of multimedia units to access services of the multimedia service provider.

44. The article of manufacture for use in a plurality of multimedia units linked to a multimedia service provider and an internet via the multimedia service provider to communicate with the service provider of claim 43, further comprising the step of the multimedia service provider generating a Web page at the IP address that includes links to enable each of the plurality of multimedia units to access services of the multimedia service provider.

45. The article of manufacture for use in a plurality of multimedia units linked to a multimedia service provider and an internet via the multimedia service provider to communicate with the service provider of claim 43, wherein the communication with the service provider enables each of the plurality of multimedia units to select multimedia programs available from the multimedia service provider.

46. The article of manufacture for use in a plurality of multimedia units linked to a multimedia service provider and an internet via the multimedia service provider to communicate with the service provider of claim 44, wherein the services of the multimedia service provider include video on demand.

47. The article of manufacture for use in a plurality of multimedia units linked to a multimedia service provider and an internet via the multimedia service provider to communicate with the service provider of claim 44, wherein the services of the multimedia service provider include an Electronic Program guide.

48. The article of manufacture for use in a plurality of multimedia units linked to a multimedia service provider and an internet via the multimedia service provider to communicate with the service provider of claim 37, wherein step a) includes:
i) designating a uniform resource locator (“URL”) for the multimedia service provider;
ii) each of the plurality of multimedia units receiving the URL; and
iii) resolving the URL into an IP address for the multimedia service provider.

49. The article of manufacture for use in a plurality of multimedia units linked to a multimedia service provider and an internet via the multimedia service provider to communicate with the service provider of claim 48, wherein the multimedia units are set top boxes.

50. The article of manufacture for use in a plurality of multimedia units linked to a multimedia service provider and an internet via the multimedia service provider to communicate with the service provider of claim 48, wherein the communication with the service provider includes information about the services available from the multimedia service provider.

51. The article of manufacture for use in a plurality of multimedia units linked to a multimedia service provider and an internet via the multimedia service provider to communicate with the service provider of claim 50, further comprising the step of the multimedia service provider generating a Web page at the IP address that includes information about the services available from the multimedia service provider.

52. The article of manufacture for use in a plurality of multimedia units linked to a multimedia service provider and an internet via the multimedia service provider to communicate with the service provider of claim 48, wherein the communication with the service provider includes the multimedia programs available from the multimedia service provider.

53. The article of manufacture for use in a plurality of multimedia units linked to a multimedia service provider and an internet via the multimedia service provider to communicate with the service provider of claim 52, further comprising the step of the multimedia service provider generating a Web page at the IP address that includes the multimedia programs available from the multimedia service provider.

54. The article of manufacture for use in a plurality of multimedia units linked to a multimedia service provider and an internet via the multimedia service provider to communicate with the service provider of claim 48, wherein the communication with the service provider enables each of the plurality of multimedia units to access services of the multimedia service provider.

55. The article of manufacture for use in a plurality of multimedia units linked to a multimedia service provider and an internet via the multimedia service provider to communicate with the service provider of claim 54, further comprising the step of the multimedia service provider generating a Web page at the IP address that includes links to enable each of the plurality of multimedia units to access services of the multimedia service provider.

56. The article of manufacture for use in a plurality of multimedia units linked to a multimedia service provider and an internet via the multimedia service provider to communicate with the service provider of claim 54, wherein the communication with the service provider enables each of the plurality of multimedia units to select multimedia programs available from the multimedia service provider.

57. The article of manufacture for use in a plurality of multimedia units linked to a multimedia service provider and an internet via the multimedia service provider to communicate with the service provider of claim 55, wherein the services of the multimedia service provider include video on demand.

58. The article of manufacture for use in a plurality of multimedia units linked to a multimedia service provider and an internet via the multimedia service provider to communicate with the service provider of claim 55, wherein the services of the multimedia service provider include an Electronic Program guide.

59. The article of manufacture for use in a plurality of multimedia units linked to a multimedia service provider and an internet via the multimedia service provider to communicate with the service provider of claim 37, wherein each of the plurality of multimedia units includes security module wherein step a) includes:
i) designating a uniform resource locator (“URL”) for the multimedia service provider on the service module;
ii) each of the plurality of multimedia units retrieving the URL from the service module; and
iii) resolving the URL into an IP address for the multimedia service provider.

60. The article of manufacture for use in a plurality of multimedia units linked to a multimedia service provider and an internet via the multimedia service provider to communicate with the service provider of claim 37, wherein each of the plurality of multimedia units includes security module wherein step a) includes:
i) designating an IP address for the multimedia service provider on the service module;
ii) each of the plurality of multimedia units retrieving the IP address from the service module.

61. The article of manufacture for use in a plurality of multimedia units linked to a multimedia service provider and an internet via the multimedia service provider to communicate with the service provider of claim 60, wherein the multimedia units are set top boxes.

62. The article of manufacture for use in a plurality of multimedia units linked to a multimedia service provider and an internet via the multimedia service provider to communicate with the service provider of claim 60, wherein the communication with the service provider includes information about the services available from the multimedia service provider.

63. The article of manufacture for use in a plurality of multimedia units linked to a multimedia service provider and an internet via the multimedia service provider to communicate with the service provider of claim 62, further comprising the step of the multimedia service provider generating a Web page at the IP address that includes information about the services available from the multimedia service provider.

64. The article of manufacture for use in a plurality of multimedia units linked to a multimedia service provider and an internet via the multimedia service provider to communicate with the service provider of claim 60, wherein the communication with the service provider includes the multimedia programs available from the multimedia service provider.

65. The article of manufacture for use in a plurality of multimedia units linked to a multimedia service provider and an internet via the multimedia service provider to communicate with the service provider of claim 64, further comprising the step of the multimedia service provider generating a Web page at the IP address that includes the multimedia programs available from the multimedia service provider.

66. The article of manufacture for use in a plurality of multimedia units linked to a multimedia service provider and an internet via the multimedia service provider to communicate with the service provider of claim 60, wherein the communication with the service provider enables each of the plurality of multimedia units to access services of the multimedia service provider.

67. The article of manufacture for use in a plurality of multimedia units linked to a multimedia service provider and an internet via the multimedia service provider to communicate with the service provider of claim 66, further comprising the step of the multimedia service provider generating a Web page at the IP address that includes links to enable each of the plurality of multimedia units to access services of the multimedia service provider.

68. The article of manufacture for use in a plurality of multimedia units linked to a multimedia service provider and an internet via the multimedia service provider to communicate with the service provider of claim 66, wherein the communication with the service provider enables each of the plurality of multimedia units to select multimedia programs available from the multimedia service provider.

69. The article of manufacture for use in a plurality of multimedia units linked to a multimedia service provider and an internet via the multimedia service provider to communicate with the service provider of claim 67, wherein the services of the multimedia service provider include video on demand.

70. The article of manufacture for use in a plurality of multimedia units linked to a multimedia service provider and an internet via the multimedia service provider to communicate with the service provider of claim 67, wherein the services of the multimedia service provider include an Electronic Program guide.

71. A multimedia unit, the multimedia unit linked to a multimedia service provider and an internet via the multimedia service provider to communicate with the service provider, the multimedia unit comprising:
a) means for receiving an Internet Protocol (“IP”) address for the multimedia service provider; and
b) means for communicating with the multimedia service provider via the IP address.

72. The multimedia unit of claim 71, wherein the multimedia unit is a set top box.

73. The multimedia unit of claim 71, wherein the communication with the service provider includes information about the services available from the multimedia service provider.

74. The multimedia unit of claim 73, wherein the multimedia service provider generates a Web page at the IP address that includes information about the services available from the multimedia service provider.

75. The multimedia unit of claim 71, wherein the communication with the service provider includes the multimedia programs available from the multimedia service provider.

76. The multimedia unit of claim 75, wherein the multimedia service provider generates a Web page at the IP address that includes the multimedia programs available from the multimedia service provider.

77. The multimedia unit of claim 71, further comprising means for enabling access to the services of the multimedia service provider.

78. The multimedia unit of claim 77, wherein the multimedia service provider generates a Web page at the IP address that includes links and the multimedia unit further comprising means for accessing the services of the multimedia service provider via the links.

79. The multimedia unit of claim 77, the means for accessing enabling the multimedia unit to select multimedia programs available from the multimedia service provider.

80. The multimedia unit of claim 78, wherein the services of the multimedia service provider include video on demand.

81. The multimedia unit of claim 78, wherein the services of the multimedia service provider include an Electronic Program guide.

82. The multimedia unit of claim 71, wherein the means for receiving includes:
i) means for receiving a uniform resource locator (“URL”) designated for the multimedia service provider; and
ii) means for receiving the IP address for the multimedia service provider resolved from the URL.

83. The multimedia unit of claim 82, wherein the multimedia unit is a set top box.

84. The multimedia unit of claim 82, wherein the communication with the service provider includes information about the services available from the multimedia service provider.

85. The multimedia unit of claim 84, wherein the multimedia service provider generates a Web page at the IP address that includes information about the services available from the multimedia service provider and the multimedia unit includes means for accessing the Web page.

86. The multimedia unit of claim 82, wherein the communication with the service provider includes the multimedia programs available from the multimedia service provider.

87. The multimedia unit of claim 86, wherein the multimedia service provider generates a Web page at the IP address that includes the multimedia programs available from the multimedia service provider and the multimedia unit includes means for accessing the Web page.

88. The multimedia unit of claim 82, wherein the multimedia unit includes means for accessing
services of the multimedia service provider.

89. The multimedia unit of claim 88, wherein the multimedia service provider generating a Web page at the IP address that includes links to services of the multimedia service provider and the multimedia unit includes means for selecting links of the Web page.

90. The multimedia unit of claim 88, wherein the Web page includes links to multimedia programs available from the multimedia service provider.

91. The multimedia unit of claim 89, wherein the services of the multimedia service provider include video on demand.

92. The multimedia unit of claim 89, wherein the services of the multimedia service provider include an Electronic Program guide.

93. The multimedia unit of claim 71, the unit including a service module and the means for receiving including:
i) means for extracting a uniform resource locator (“URL”) designated for the multimedia service provider from the service module; and
ii) means for receiving the IP address for the multimedia service provider resolved from the URL.

94. The multimedia unit of claim 71, the unit further comprising a security module wherein an IP address for the multimedia service provider is stored and wherein the means for receiving includes means for retrieving the IP address from the service module.

95. The multimedia unit of claim 94, wherein the multimedia unit is a set top box.

96. The multimedia unit of claim 94, the unit further comprising means for communicating with the service provider via the IP address and retrieving information about the services available from the multimedia service provider.

97. The multimedia unit of claim 96, wherein the multimedia service provider generates a Web page at the IP address that includes information about the services available from the multimedia service provider.

98. The multimedia unit of claim 94, wherein the unit further includes means for retrieving information about the services available from the service provider from the IP address.

99. The multimedia unit of claim 98, wherein the multimedia service provider generates a Web page at the IP address that includes the multimedia programs available from the multimedia service provider and the unit further comprises means for retrieving the Web page at the IP address.

100. The multimedia unit of claim 94, wherein further includes means for accessing services available from the service provider from the IP address.

101. The multimedia unit of claim 100, wherein the multimedia service provider generates a Web page at the IP address that includes links to enable the multimedia unit to access services of the multimedia service provider.

102. The multimedia unit of claim 100, wherein the Web page includes links to enable the multimedia unit to select multimedia programs available from the multimedia service provider.

103. The multimedia unit of claim 101, wherein the services of the multimedia service provider include video on demand.

104. The multimedia unit of claim 101, wherein the services of the multimedia service provider include an Electronic Program guide.

105. A system for communicating multimedia service provider information in a multimedia service provider network comprising:
a) a multimedia service provider coupled to the network, the multimedia service provider having an Internet Protocol (“IP”) address and comprising means for communicating the information via the IP address; and The multimedia unit of claim 101, wherein the services of the multimedia service
b) a multimedia unit coupled to the network, the unit comprising means for communicating the information with the multimedia service provider via the IP address.

106. The system of claim 105, wherein the multimedia unit is a set top box.

107. The system of claim 106, wherein the service provider information includes the services available from the multimedia service provider.

108. The system of claim 106, the multimedia service provider further comprising means for generating a Web page at the IP address that includes information about the services available from the multimedia service provider.

109. The system of claim 108, wherein the Web page includes the multimedia programs available from the multimedia service provider.

110. The system of claim 105, the multimedia service provider further comprising means for generating a Web page at the IP address that includes the multimedia programs available from the multimedia service provider.

111. The system of claim 105, the multimedia service provider further comprising means for generating a Web page at the IP address that includes links to enable the multimedia unit to access services of the multimedia service provider.

112. The system of claim 111, wherein the access services of the multimedia service provider include video on demand.

113. The system of claim 111, wherein the access services of the multimedia service provider include an Electronic Program guide.

114. The system of claim 105, wherein the multimedia unit further comprises a security module wherein the security module includes the IP address of the multimedia service provider.

115. A system for communicating multimedia service provider information in a multimedia service provider network comprising: The multimedia unit of claim 101, wherein the services of the multimedia service
a) a multimedia service provider coupled to the network, the provider comprising:
1) means for generating a Web page of the information; and
2) first means for communicating the Web page via the network; and The multimedia unit of claim 101, wherein the services of the multimedia service
b) a multimedia unit coupled to the network, the unit comprising second means for communicating with the Web page via the network.

116. The system of claim 115, wherein the multimedia unit is a set top box.

117. The system of claim 116, wherein the Web page includes the services available from the multimedia service provider.

118. The system of claim 106, the multimedia service provider having an IP address, the first means comprising means for communicating the Web page via the IP address and the second means comprising means for communicating the Web page via the IP address.

119. The system of claim 118, wherein the Web page includes the multimedia programs available from the multimedia service provider.

120. The system of claim 115, the multimedia service provider further comprising means for generating a Web page that includes links to enable the multimedia unit to access services of the multimedia service provider.

121. The system of claim 118, the multimedia service provider further comprising means for generating a Web page that includes links to enable the multimedia unit to access services of the multimedia service provider.

122. The system of claim 121, wherein the access services of the multimedia service provider include video on demand.

123. The system of claim 122, wherein the access services of the multimedia service provider include an Electronic Program guide.

124. The system of claim 118, wherein the multimedia unit further comprises a security module wherein the security module includes the IP address of the multimedia service provider.
